(19) United States
(12) Patent Application Publication
(10) Pub. No.: US 2021/0336250 A1
(43) Pub. Date: Oct. 28, 2021

(54) FREESTANDING LAMINATE, METHOD FOR THE MANUFACTURE THEREOF, AND METHOD OF MAKING A LEAD CARBON BATTERY

(71) Applicant: ROGERS CORPORATION, Chandler, AZ (US)

(72) Inventors: Wei Wang, Waltham, MA (US); Brett Kilhenny, Mystic, CT (US); Mark St. Jean, Dayville, CT (US)

(21) Appl. No.: 17/230,026

(22) Filed: Apr. 14, 2021

Related U.S. Application Data
(60) Provisional application No. 63/013,652, filed on Apr. 22, 2020.

(51) Int. Cl. H01M 4/22; H01M 4/62; H01M 10/12; H01M 50/489; H01M 4/587

(52) U.S. Cl. CPC H01M 4/22; H01M 4/625; H01M 4/623; H01M 2300/0005; H01M 50/489; H01M 4/587; H01M 10/12

(57) ABSTRACT

A freestanding laminate includes a separator and an anode layer. The anode layer includes an electrically conductive carbon active material including particular amounts of an activated carbon; a binder; and an electrically conductive filler. The anode layer is in direct physical contact with a first side of the separator. The freestanding laminate is particularly useful for use in various energy storage devices.

### CROSS-REFERENCE TO RELATED APPLICATIONS

This application claims priority to and the benefit of U.S. Provisional Application No. 63/013,652 filed on Apr. 22, 2020, the entire contents of which is incorporated herein by reference.

### BACKGROUND

This disclosure is related to battery laminates, methods of making the laminates, and batteries containing the laminates.

Batteries are commonly-used energy sources. Typically, a battery includes a negative electrode and a positive electrode. Conventional, commercial lead acid batteries rely on negative electrodes (anodes) that are composed of lead metal and positive electrodes (cathodes) that are composed of lead dioxide, while lead carbon batteries include anodes including a carbonaceous species. The electrodes of a lead acid or lead carbon battery are disposed in an acidic electrolytic medium. During discharge of a battery, chemical reactions occur wherein an active positive electrode material is reduced, and an active negative electrode material is oxidized. During the reactions, electrons flow from the negative electrode to the positive electrode through a load, and ions in the electrolytic medium flow between the electrodes. To prevent direct reaction of the active positive electrode material and the active negative electrode material, the electrodes are typically mechanically and electrically isolated from each other by a separator.

It would be advantageous to provide a separator-anode laminate as a single structure that can be readily handled, cut into a desired shape, and adhered to a cathode material for direct use in energy storage device applications, in particular, bipolar battery applications.

### SUMMARY

A freestanding laminate comprises a separator; and an anode layer, and comprising an electrically conductive carbon active material comprising greater than or equal to 60 weight percent of an activated carbon; 1 to 40 weight percent of a binder; and 0 to 10 weight percent of an electrically conductive filler; wherein weight percent of each component is based on the total weight of the anode layer; and wherein the anode layer is in direct physical contact with a first side of the separator.

A method of making the freestanding laminate comprises applying the anode layer to the first side of the separator.

An energy storage device comprises the freestanding laminate.

A method of making a lead carbon battery comprises: attaching a lead oxide cathode to the separator of the freestanding laminate; enclosing the lead oxide cathode adhered to the freestanding laminate in a case; and introducing an acid into the case such that the cathode and the anode are at least partially immersed in the acid.

The above described and other features are exemplified by the following figures and detailed description.

### BRIEF DESCRIPTION OF THE DRAWINGS

The following figures are exemplary aspects wherein the like elements are numbered alike. The Figures that are illustrative of the examples are not intended to limit devices made in accordance with the disclosure to the materials, conditions, or process parameters set forth herein.

FIG. 1 is a schematic illustration of a freestanding laminate according to an aspect.

FIG. 2 is a schematic illustration of a lead carbon battery according to an aspect.

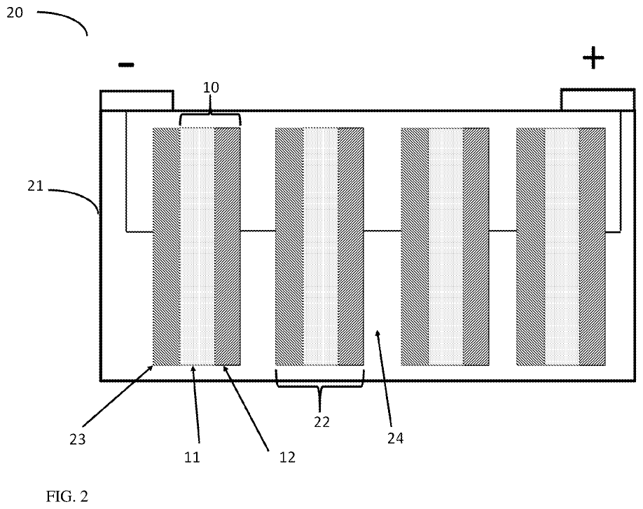

### DETAILED DESCRIPTION

The present inventors have advantageously discovered that a freestanding laminate can be prepared comprising a separator and an anode layer. The freestanding laminate can be used in various energy storage devices, for example a lead carbon battery. The use of the freestanding laminate to produce the lead carbon battery greatly simplifies the manufacturing process, and also advantageously allows for the use of existing lead acid bipolar battery production equipment. The freestanding laminate can be easily handled and cut into a desired shape for direct use in an energy storage device.

Accordingly, an aspect of the present disclosure is a freestanding laminate. The freestanding laminate comprises a separator and an anode layer. As used herein, the term “freestanding laminate” refers to a laminate that is not adhered or supported by any other layers, for example an underlying substrate. In an aspect, the freestanding laminate is a laminate that is self-supporting, which can be mechanically manipulated or moved without the need of a substrate (or other supporting layer) adhered or affixed to the laminate. Thus, in an aspect, the freestanding laminate of the present disclosure refers to an individual laminate free of any other supporting layers. In some aspects, the freestanding laminate can consist of the separator and the anode layer. The anode layer is in direct physical contact with a first side of the separator.

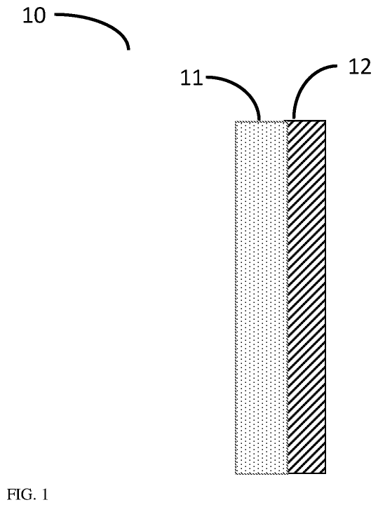

A freestanding laminate according to the present disclosure is depicted in FIG. 1. The freestanding laminate 10 includes a separator 11 having an anode layer 12 disposed on the separator, where the separator and the anode layer are in direct physical contact.

The separator of the freestanding laminate can generally include any acid-resistant, porous sheet that has a thickness of 3 millimeters or less and a porosity of greater than 30%. As used herein, an “acid resistant” sheet is one which is able to function in the presence of the sulfuric acid electrolyte (e.g., one which is stable in dilute aqueous sulfuric acid having a specific gravity of 1 to 1.4, as commonly used in lead acid batteries, at a temperature of −40 to 80° C.). For example, the separator can comprise an absorbent glass mat, a polyvinyl chloride, a polyolefin, a non-woven fiber glass mat, an activated carbon cloth, a carbon nanofiber cloth, a carbon nanotube cloth, and the like. In an aspect, the separator can be a non-fibrous separator. Particularly preferred can be materials that can be used in a roll-to-roll process. Exemplary polyolefins can include polyethylene, polypropylene, polytetrafluoroethylenes, ethylene-propylene copolymers, and the like. An exemplary separator comprises polyvinyl chloride (PVC) having a volume porosity of 30-95%, preferably 70 to 80%, more preferably 75%. Methods for determining porosity of a separator material are generally known and can be readily determined by a person of skill in the art.

In an aspect, the separator can have a thickness of 3 millimeters or less, for example 0.005 to 3 millimeters, or 0.005 to 1.5 millimeters, or 0.025 to 0.3 millimeters.

The freestanding laminate also comprises an anode layer. The anode layer comprises an electrically conductive carbon active material. The electrically conductive carbon active material comprises an activated carbon, a binder, and optionally, an electrically conductive filler.

The activated carbon is electrochemically stable in sulfuric acid. The activated carbon can have a surface area of greater than or equal to 50 meters squared per gram (m²/g), or greater than or equal to 500 m²/g, or greater than or equal to 1,000 m²/g, 1,500 m²/g, or 500 to 3,000 m²/g. The activated carbon can have a D₅₀ particles size by weight of 0.1 to 100 micrometers, or 1 to 100 micrometers, or 1 to 50 micrometers, or 5 to 10 micrometers, or 15 to 50 micrometers, or 0.1 to 10 micrometers. In aspect, the activated carbon can be particulate having a D₅₀ particle size by weight of 0.01 to 10 micrometers and/or a BET surface area at least 50 m²/g, and preferably larger than 1000 m²/g. D₅₀ particles size by weight can be determined by methods that are generally known, for example, by a laser light scattering method. The activated carbon can have a multimodal particle size, for example, having a first mode that is at least 7 times greater than that of the second mode. For example, the first mode can have peak of greater than or equal to 7 or greater than or equal to 35 micrometers and the second mode can have a peak of less than or equal to 1 micrometer, or less than or equal to 5 micrometers. An exemplary activated carbon can include ELITE-C available from Calgon Carbon LLC, or POWDERED-S available from General Carbon Corporation.

The activated carbon can be present in the anode layer in an amount of greater than or equal to 60 weight percent, based on the total weight of the anode layer. Within this range, the activated carbon can be present in an amount of 85 to 99 weight percent, or 90 to 98 wt %, or 90 to 96 wt %.

In addition to the activated carbon, the electrically conductive carbon active material comprises a binder. The binder can be a fluoropolymer. “Fluoropolymer” as used herein includes homopolymers and copolymers that comprise repeat units derived from a fluorinated alpha-olefin monomer, i.e., an alpha-olefin monomer that includes at least one fluorine atom substituent, and optionally, a non-fluorinated, ethylenically unsaturated monomer reactive with the fluorinated alpha-olefin monomer. Exemplary fluorinated alpha-olefin monomers include CF₂═CF₂, CHF═CF₂, CH₂═CF₂, CHCl═CHF, CClF=CF₂, CCl₂=CF₂, CClF═CClF, CHF═CCl₂, CH₂═CClF, CCl₂═CClF, CF₃CF═CF₂, CF₃CF═CHF, CF₃CH═CF₂, CF₃CH═CH₂, CHF₂CH═CHF, and CF₃CH═CH₂, and perfluoro(C₂₋₈alkyl)vinylethers such as perfluoromethyl vinyl ether, perfluoropropyl vinyl ether, and perfluorooctylvinyl ether. The fluorinated alpha-olefin monomer can comprise at least one of tetrafluoroethylene (CF₂═CF₂), chlorotrifluoroethylene (CClF═CF₂), (perfluorobutyl)ethylene, vinylidene fluoride (CH₂═CF₂), or hexafluoropropylene (CF₂═CFCF₃). Exemplary non-fluorinated monoethylenically unsaturated monomers include ethylene, propylene, butene, or ethylenically unsaturated aromatic monomers such as styrene or alpha-methyl-styrene. Exemplary fluoropolymers include poly(chlorotrifluoroethylene) (PCTFE), poly(chlorotrifluoroethylene-propylene), poly(ethylene-tetrafluoroethylene) (ETFE), poly(ethylene-chlorotrifluoroethylene) (ECTFE), poly(hexafluoropropylene), poly(tetrafluoroethylene) (PTFE), poly(tetrafluoroethylene-ethylene-propylene), poly(tetrafluoroethylene-hexafluoropropylene) (also known as fluorinated ethylene-propylene copolymer (FEP)), poly(tetrafluoroethylene-propylene) (also known as fluoroelastomer) (FEPM), poly(tetrafluoroethylene-perfluoropropylene vinyl ether), a copolymer having a tetrafluoroethylene backbone with a fully fluorinated alkoxy side chain (also known as a perfluoroalkoxy polymer (PFA)) (for example, poly(tetrafluoroethylene-perfluoroproplyene vinyl ether)), polyvinylfluoride (PVF), polyvinylidene fluoride (PVDF), poly(vinylidene fluoride-chlorotrifluoroethylene), perfluoropolyether, perfluorosulfonic acid, or perfluoropolyoxetane, preferably perfluoroalkoxy alkane polymer, fluorinated ethylene-propylene, or more preferably perfluoroalkoxy alkane polymer.

In an aspect, the fluoropolymer can comprise poly(vinylidene fluoride). The poly(vinylidene fluoride) can comprise at least one of a poly(vinylidene fluoride) homopolymer or a poly(vinylidene fluoride) copolymer. In an aspect, the binder can comprise a fibrillated poly(vinylidene fluoride), preferably wherein the poly(vinylidene fluoride) comprises a poly(vinylidene fluoride) copolymer. The poly(vinylidene fluoride) copolymer can comprise repeat units derived from at least one of chlorotrifluoroethylene, tetrafluoroethylene (CF₂═CF₂), chlorotrifluoroethylene (CClF═CF₂), (perfluorobutyl)ethylene, hexafluoropropylene (CF₂═CFCF₃), ethylene, propylene, butene, or an ethylenically unsaturated aromatic monomer such as styrene or alpha-methyl-styrene. In an aspect, the poly(vinylidene fluoride) copolymer comprises repeat units derived from chlorotrifluoroethylene. An example of a poly(vinylidene fluoride) is KYNAR 761 available from Arkema.

The binder can be present in an amount of 1 to 40 weight percent, based on the total weight of the anode layer. Within this range, the binder can be present in an amount of 1 to 20 weight percent, or 1 to 15 weight percent, or 1 to 10 weight percent, or 5 to 10 weight percent.

In addition to the activated carbon and the binder, the electrically conductive carbon active material can optionally further comprise an electrically conductive filler. In an aspect, the electrically conductive filler is present. When present, the electrically conductive filler can advantageously provide a beneficial decrease in the voltage drop in the anode layer when incorporated into a lead carbon battery structure. This can enable the battery cell to operate at a high power with less conversion of energy to heat and can also increase the cell capacity over a given operating voltage range. The electrically conductive filler can comprise at least one of graphite, carbon nanotubes, carbon fibers, graphene, or carbon black. Examples of carbon black are SUPER-P from Imersys, VULCAN XC-72 from Cabot Corporation, and SHAWINIGAN BLACK from Chevron Corporation. Examples of carbon nanotubes are those commercially available from Showa Denko K.K. and Bayer AG.

The electrically conductive filler can be present in an amount of 0 to 10 weight percent, based on the total weight of the anode layer. Within this range, the electrically conductive filler can be present in an amount of greater than 0 to 10 weight percent, or 1 to 5 weight percent.

The anode layer can optionally comprise a reinforcing filler. The reinforcing filler can generally comprise any reinforcing filler, preferably one having a high aspect ratio (e.g., an aspect ratio of greater than 1:1, or greater than 5:1, or greater than 10:1, or greater than 20:1, or greater than 40:1). For example, the reinforcing filler can comprise nanofibers or nanoplates. Without wishing to be bound by theory, it is believed that such reinforcing fillers can improve cohesion or mechanical properties of the composite.

Possible reinforcing fillers can include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well a combination thereof. The reinforcing fillers can be coated with a layer of metallic material to facilitate conductivity, or surface treated with silanes to improve adhesion and dispersion with the polymer matrix.

In an aspect, the reinforcing filler can preferably be a fibrous reinforcing filler, for example, glass fibers, carbon fibers, polymeric fibers, provided that the polymeric fibers are selected such that they are acid resistant, high modulus fibers, inorganic fibers such as those derived from blends comprising at least one of aluminum silicates, aluminum oxides, magnesium oxides, and calcium sulfate hemihydrate or the like, silica microtubes or nanotubes, carbon microtubes or nanotubes, and the like, or a combination of any of the foregoing fibrous fillers. For example, suitable polymeric fibers can include poly(ether ketone), polyimide, poybenzoxazole, poly(phenylene sulfide), polyesters, polyethylene, aromatic polyamides, aromatic polyimides, polyetherimides, polytetrafluoroethylene, and poly(vinyl alcohol), as well a combination thereof. Preferably, a polymeric fiber can include aramid fibers (e.g., NOMEX fibers). The reinforcing filler can be coated with a layer of metallic material to facilitate conductivity, or surface treated with silanes to improve adhesion and dispersion with the anode layer. Glass fibers can include E, A, C, ECR, R, S, D, or NE glasses, or the like. The reinforcing fillers can be provided in the form of monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. Co-woven structures include glass fiber-carbon fiber, carbon fiber-aromatic polyimide (aramid) fiber, and aromatic polyimide fiberglass fiber or the like. Fibrous fillers can be supplied in the form of, for example, rovings, woven fibrous reinforcements, such as 0-90 degree fabrics or the like; non-woven fibrous reinforcements such as continuous strand mat, chopped strand mat, tissues, papers and felts or the like. In an aspect, when present, the reinforcing filler can comprise glass fibers, carbon fibers, polymeric fibers, or a combination thereof, preferably glass fibers.

When present, the reinforcing filler can be included in the anode layer in an amount of up to 20 weight percent, for example, greater than 0 to 20 weight percent, of 0.1 to 20 weight percent, based on the total weight of the anode layer.

The anode layer can have a thickness of 0.01 to 10 millimeters, or 0.1 to 8 millimeters. The anode layer can have an increased thickness of greater than or equal to 0.5 millimeters, or 0.5 to 10 millimeters, or 2 to 10 millimeters, or 1 to 5 millimeters, or 1.5 to 2.5 millimeters, or 2.5 to 5 millimeters. The anode layer can have a density of 0.5 to 1.0 gram per cubic centimeter (g/cm³). The anode layer can have a porosity of 30 to 75 volume percent, or 40 to 75 volume percent, or 50 to 75 volume percent, or 40 to 70 volume percent, based on the total volume of the active layer.

The freestanding laminate can comprise a separator; and an anode layer comprising an electrically conductive carbon active material comprising greater than or equal to 60 weight percent of an activated carbon; 1 to 40 weight percent of a binder; and 0 to 10 weight percent of an electrically conductive filler; wherein weight percent of each component is based on the total weight of the anode layer; and wherein the anode layer is in direct physical contact with a first side of the separator. The separator can comprise an acid-resistant, porous sheet having a thickness of 3 millimeters or less and a porosity of greater than 30%. The separator can comprise an absorbent glass mat, a polyvinyl chloride, a polyolefin, a non-woven fiber glass mat, an activated carbon cloth, a carbon nanofiber cloth, or a carbon nanotube cloth. The electrically conductive filler can be present in the electrically conductive carbon active material, and can comprise at least one of carbon black, graphite, carbon nanotubes, carbon fibers, or graphene. The binder can comprise poly(vinylidene fluoride), preferably a fibrillated poly(vinylidene fluoride), more preferably wherein the poly(vinylidene fluoride) comprises a poly(vinylidene fluoride) copolymer or a poly(vinylidene fluoride) copolymer with chlorotrifluoroethylene. The anode layer can comprise 85 to 99 weight percent of the activated carbon based on the total weight of the active layer, and 1 to 15 weight percent of the binder based on the total weight of the active layer. The anode layer can have a thickness of 0.5 to 10 millimeters, or 2 to 10 millimeters, or 1.5 to 2.5 millimeters. The anode layer can have a density of 0.5 to 1.0 grams per cubic centimeter. The anode layer can have a porosity of 30 to 75 volume percent. The anode layer can further comprise a reinforcing filler. The reinforcing filler can comprise glass fibers, carbon fibers, polymeric fibers, or a combination thereof, preferably glass fibers.

The freestanding laminate can be made by a method comprising applying the anode layer to the first side of the separator. Applying the anode layer to the separator can be accomplished by various methods including calendaring, a paper-making process, and compression molding. For example, in an aspect, the method comprises forming a powder composition comprising the electrically conductive carbon active material, applying the powder composition to the first side of the separator, and calendering the combination of the powder composition and the separator to form the freestanding laminate comprising the anode layer and the separator in direct physical contact. In an aspect, the method comprises applying a flocculated material comprising the electrically conductive carbon active material to the separator (e.g., by draining the flocculated material over the separator, followed by drying), and calendering the combination of the dried flocculated material and the separator to form the freestanding laminate comprising the anode layer and the separator in direct physical contact. Calendering to provide the laminate can be, for example, using a pressure of 0.1 to 1.5 MPa, and at a temperature of 20 to 200° C. In an aspect, the method comprises forming a powder composition comprising the electrically conductive carbon active material, applying the powder composition to the first side of the separator, and compression molding the powder to the separator to provide the freestanding laminate. Compression molding can be with heat, for example at a temperature of 25 to 80° C.

The method of making the freestanding laminate can further comprise cutting the laminate into a preselected shape, for example by die-cutting the laminate. For example, the freestanding laminate can be die cut to a preselected shape that can be, but is not limited to, rectangular, square, circular, oval, disc shaped, and the like. In an aspect, the freestanding laminate can be rectangular, and can be complementary to the shape of a positive electrode for use in a battery, which can also be overall rectangular in shape.

The powder composition comprising the electrically conductive carbon active material used to prepare the anode layer can be prepared, for example, by a method as described in U.S. patent application Ser. Nos. 16/404,858 and 16/675,408, each of which is incorporated by reference herein in its entirety.

In a particularly advantageous feature, use of the freestanding laminate can provide an improved method of making a lead carbon battery. Accordingly, an aspect of the present disclosure is a method of making a lead carbon battery. The method comprises attaching a lead oxide cathode to the second side of the separator of the freestanding laminate (i.e., on a side opposite the anode layer). Advantageously, because the anode layer is provided in the form of the laminate with the separator, an additional attaching step (i.e., of attaching an anode layer to the separator) is not needed when the laminate is used. Furthermore, use of the laminate of the present disclosure enables use of existing processes as they relate to lead acid batteries. Thus the freestanding laminate provides a significant commercial advantage to a method of making a lead carbon battery.

The method further comprises enclosing the combination of the lead oxide cathode adhered to the freestanding laminate in a case. An acid is introduced to the case such that the cathode and the anode are at least partially immersed in an acidic medium. The acidic medium can comprise, for example, sulfuric acid, preferably a liquid sulfuric acid. The medium can comprise a gel electrolyte comprising an aqueous sulfuric acid and a thickening agent in an amount sufficient to render the electrolyte a gel. The gel electrolyte can comprise an alkaline earth metal (for example, a silicate, a sulfate, or a phosphate of calcium or strontium). The anode, cathode and separator can be in direct physical contact with the medium. The assembly described herein can be made by methods such as laminating, printing, and/or a roll-to-roll process, preferably a roll-to-roll process.

Accordingly, the present disclosure advantageously provides an improved method of manufacturing a lead carbon battery through the use of a freestanding laminate including an anode layer and a separator. The freestanding laminate can be easily handled and cut to a desired shape as needed, and further simplifies the process of manufacturing the battery. Accordingly, a significant improvement is provided by the present disclosure.

This disclosure further encompasses the following aspects.

Aspect 1: A freestanding laminate comprising a separator; and an anode layer comprising an electrically conductive carbon active material comprising greater than or equal to 60 weight percent of an activated carbon; 1 to 40 weight percent of a binder; and 0 to 10 weight percent of an electrically conductive filler; wherein weight percent of each component is based on the total weight of the anode layer; and wherein the anode layer is in direct physical contact with a first side of the separator.

Aspect 2: The freestanding laminate of aspect 1, wherein the separator comprises an acid-resistant, porous sheet having a thickness of 3 millimeters or less and a porosity of greater than 30%.

Aspect 3: The freestanding laminate of aspect 1 or 2, wherein the separator comprises an absorbent glass mat, a polyvinyl chloride, a polyolefin, a non-woven fiber glass mat, an activated carbon cloth, a carbon nanofiber cloth, or a carbon nanotube cloth.

Aspect 4: The freestanding laminate of any of aspects 1 to 3, wherein the electrically conductive filler is present, and comprises at least one of carbon black, graphite, carbon nanotubes, carbon fibers, or graphene.

Aspect 5: The freestanding laminate of any of aspects 1 to 4, wherein the binder comprises poly(vinylidene fluoride), preferably a fibrillated poly(vinylidene fluoride), more preferably wherein the poly(vinylidene fluoride) comprises a poly(vinylidene fluoride) copolymer or a poly(vinylidene fluoride) copolymer with chlorotrifluoroethylene.

Aspect 6: The freestanding laminate of any of aspects 1 to 5, wherein the anode layer comprises 85 to 99 weight percent of the activated carbon based on the total weight of the active layer, and 1 to 15 weight percent of the binder based on the total weight of the active layer.

Aspect 7: The freestanding laminate of any of aspects 1 to 6, wherein the anode layer has a thickness of 0.5 to 10 millimeters, or 2 to 10 millimeters, or 1.5 to 2.5 millimeters.

Aspect 8: The freestanding laminate of any of aspects 1 to 7, wherein the anode layer has a density of 0.5 to 1.0 grams per cubic centimeter.

Aspect 9: The freestanding laminate of any of aspects 1 to 8, wherein the anode layer has a porosity of 30 to 75 volume percent.

Aspect 10: The freestanding laminate of any of aspects 1 to 9, wherein the anode layer further comprises a reinforcing filler.

Aspect 11: The freestanding laminate of aspect 10, wherein the reinforcing filler comprises glass fibers, carbon fibers, polymeric fibers, or a combination thereof, preferably glass fibers.

Aspect 12: A method of making a freestanding laminate comprising a separator; and an anode layer comprising an electrically conductive carbon active material comprising greater than or equal to 60 weight percent of an activated carbon; 1 to 40 weight percent of a binder; and 0 to 10 weight percent of an electrically conductive filler; wherein weight percent of each component is based on the total weight of the anode layer; and wherein the anode layer is in direct physical contact with a first side of the separator; the method comprising applying the anode layer to the first side of the separator.

Aspect 13: The method of aspect 12, wherein the applying comprises forming a powder comprising the electrically conductive carbon active material; applying the powder to the separator; and calendering to provide the freestanding laminate.

Aspect 14: The method of aspect 12, wherein the applying comprises applying a flocculated material comprising the electrically conductive carbon active material to the separator; and calendering to provide the freestanding laminate.

Aspect 15: The method of aspect 12, wherein the applying comprises forming a powder comprising the electrically conductive carbon active material; applying the powder to the separator; and compression molding the powder to the separator to provide the freestanding laminate.

Aspect 16: The method of any of aspects 12 to 15, further comprising cutting the freestanding laminate into a preselected shape.

Aspect 17: An energy storage device comprising the freestanding laminate of any of aspects 1 to 11.

Aspect 18: A method of making a lead carbon battery, the method comprising: attaching a lead oxide cathode to the separator of the freestanding laminate of any of aspects 1 to 11; enclosing the lead oxide cathode adhered to the freestanding laminate in a case; and introducing an acid into the case such that the cathode and the anode are at least partially immersed in the acid.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some aspects,” “an aspect,” and so forth, means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element or in “direct physical contact with” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A freestanding laminate, comprising
a separator; and
an anode layer comprising an electrically conductive carbon active material comprising greater than or equal to 60 weight percent of an activated carbon;
1 to 40 weight percent of a binder; and
0 to 10 weight percent of an electrically conductive filler;
wherein weight percent of each component is based on the total weight of the anode layer; and
wherein the anode layer is in direct physical contact with a first side of the separator.

2. The freestanding laminate of claim 1, wherein the separator comprises an acid-resistant, porous sheet having a thickness of 3 millimeters or less and a porosity of greater than 30%.

3. The freestanding laminate of claim 1, wherein the separator comprises an absorbent glass mat, a polyvinyl chloride, a polyolefin, a non-woven fiber glass mat, an activated carbon cloth, a carbon nanofiber cloth, or a carbon nanotube cloth.

4. The freestanding laminate of claim 1, wherein the electrically conductive filler is present, and comprises at least one of carbon black, graphite, carbon nanotubes, carbon fibers, or graphene.

5. The freestanding laminate of claim 1, wherein the binder comprises poly(vinylidene fluoride).

6. The freestanding laminate of claim 1, wherein the anode layer comprises 85 to 99 weight percent of the activated carbon based on the total weight of the active layer, and 1 to 15 weight percent of the binder based on the total weight of the active layer.

7. The freestanding laminate of claim 1, wherein the anode layer has a thickness of 0.5 to 10 millimeters.

8. The freestanding laminate of claim 1, wherein the anode layer has a density of 0.5 to 1.0 grams per cubic centimeter.

9. The freestanding laminate of claim 1, wherein the anode layer has a porosity of 30 to 75 volume percent.

10. The freestanding laminate of claim 1, wherein the anode layer further comprises a reinforcing filler.

11. The freestanding laminate of claim 10, wherein the reinforcing filler comprises glass fibers, carbon fibers, polymeric fibers, or a combination thereof.

12. A method of making a freestanding laminate comprising
a separator; and
an anode layer comprising an electrically conductive carbon active material comprising greater than or equal to 60 weight percent of an activated carbon;
1 to 40 weight percent of a binder; and
0 to 10 weight percent of an electrically conductive filler;
wherein weight percent of each component is based on the total weight of the anode layer; and
wherein the anode layer is in direct physical contact with a first side of the separator;
the method comprising
applying the anode layer to the first side of the separator.

13. The method of claim 12, wherein the applying comprises
forming a powder comprising the electrically conductive carbon active material;
applying the powder to the separator; and
calendering to provide the freestanding laminate.

14. The method of claim 12, wherein the applying comprises
applying a flocculated material comprising the electrically conductive carbon active material to the separator; and
calendering to provide the freestanding laminate.

15. The method of claim 12, wherein the applying comprises
forming a powder comprising the electrically conductive carbon active material;
applying the powder to the separator; and
compression molding the powder to the separator to provide the freestanding laminate.

16. The method of any of claim 12, further comprising cutting the freestanding laminate into a preselected shape.

17. An energy storage device comprising the freestanding laminate of claim 1.

18. A method of making a lead carbon battery, the method comprising:
attaching a lead oxide cathode to the separator of the freestanding laminate of claim 1;
enclosing the lead oxide cathode adhered to the freestanding laminate in a case; and introducing an acid into the case such that the cathode and the anode are at least partially immersed in the acid.
